(19) United States
(12) Patent Application Publication
(10) Pub. No.: US 2007/0119187 A1
(43) Pub. Date: May 31, 2007

(54) Thermoelectric unibody cooler apparatus

(76) Inventors: Mark Charles Kitchens, Athens, TX (US); Regis Marie-Jean Wandres, Athens, TX (US); John Chiu, Taipei (TW)

Correspondence Address: Mark Kitchens, 1107 Bel Air, Athens, TX, 75751, US

(21) Appl. No.: 11/312,940

(22) Filed: Dec. 20, 2005

Related U.S. Application Data
(63) Continuation-in-part of application No. 11/290,177, filed on Nov. 30, 2005.

(51) Int. Cl. F25B 21/02; F25D 19/00; F17C 13/00; F25B 21/00

(52) U.S. Cl. 62/3.6; 62/457.9; 62/298

(57) ABSTRACT

Thermoelectric unibody cooler apparatus with a unibody insulated vessel, a unibody insulated lid, and a thermoelectric heat pump assembly. A preferred embodiment includes the unibody insulated vessel manufactured as a single piece of semi-rigid insulating material being both insulation and structural support. A preferred embodiment includes the thermoelectric heat pump assembly assembled as one integral cassette and where the integral cassette forms a dissengageable friction and thermal bond with a compatible mounting area of the unibody insulated vessel.

### CROSS REFERENCE TO RELATED APPLICATIONS

This is a continuation in part of Ser. No. 11/290,177, filed on Nov. 30, 2005, titled “Universal Thermoelectric Module Apparatus”

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of thermoelectric portable coolers and more specifically to thermoelectric unibody cooler apparatus with removable thermoelectric engine.

There are many consumer grade portable coolers on the market today. Some coolers use passive cooling technology such as ice, ice pack, gel pack, others use active cooling technology such as compressors, gas-absorption, or other heat pumping technology. A common low cost heat pump used in the consumer coolers industry is the thermoelectric engine. A thermoelectric engine uses a low cost Peltier chip, generally sandwiched between two metallic masses to transfer heat from the inside of the cooler to the outside surrounding environment.

Consumer grade thermoelectric coolers are the result of the merging of two types of prior inventions. On one hand there is the insulated container as described in U.S. Pat. No. 4,873,841 to Bradshaw, this particular prior art describes what is known in the industry as a hard side cooler, made of rigid materials. There are different types of insulated containers, for example U.S. Pat. No. 5,181,555 to Chruniak discloses what is known in the industry as a soft-side cooler, made of flexible materials. On the other hand there is the thermoelectric heat pump. U.S. Pat. No. 2,872,788 to Lindenblad describing a thermoelectric heat pump for a refrigeration application. When combining the consumer portable cooler technology with a refrigerating thermoelectric heat pump the result is the portable thermoelectric cooler. There are many thermoelectric portable coolers on the market today, for example, such as the one described in U.S. Pat. No. 6,301,901 B1 to Coffee.

The prior art in the field of portable thermoelectric coolers discloses a variety of inventions, each addressing a particular design items associated with this field of consumer products. Most prior inventions require the use a custom-designed, custom-built, fully integrated thermoelectric heat pumps. U.S. Pat. No. 5,319,937 to Fritsch teaches about a hard-side cooler with a unique ventilation system; U.S. Pat. No. 6,073,789 to Lundblade describes another hard-side cooler with a custom-built, fully integrated thermoelectric system. Such inventions do provide a durable cooler with assumable decent cooling ability but require many engineering hours and significant manufacturing and logistic investments because each of these inventions require the development of a custom-designed body and engine where the two are also fully integrated together.

To try to reduce some of the negative cost effect of a fully integrated thermoelectric engine, some prior arts disclosed a thermoelectric engine that can be installed as one-piece into the cooler, such as U.S. Pat. No. 6,301,901 B1 to Coffee which discloses a thermoelectric engine built as an integral cassette that can be installed and removed in one piece. Another example of such attempted improvement is disclosed in U.S. Pat. No. 5,301,508 to Kahl. However, each of these two inventions still requires the use of custom-designed thermoelectric engines that will fit only with one cooler. Although these inventions claim a thermoelectric engine installable and removable as one integral piece they still require the use of mounting hardware such as screws and additional parts to interface between the cooler and the engine such as mounting plates. There might be a slight cost saving during manufacturing and repair, but not in material, thermoelectric engine construction, or re-usability of the same thermoelectric engine with multiple coolers. U.S. Pat. No. 5,501,076 to Sharp discloses yet another example of such prior art.

U.S. Pat. Nos. 4,007,600 and 4,242,874 to Simms also describe a type of thermoelectric engine, not specifically designed for a particular cooler as these inventions are intended to be commercialized as retrofitting kits to convert a passive cooler into an active cooler. Here again, the use of mounting hardware and hard interface surfaces are necessary. Additionally, these two inventions disclose a flawed thermal insulation method that omits the use of a flexible insulating material between the thermoelectric engine and the cooler's body that will result in poor performance and rapid deterioration of the thermoelectric engine.

Another invention, U.S. Pat. No. 5,315,830 to Doke reveals another modular thermoelectric engine assembly meant to be installed in a wide variety of insulated vessels. This invention however does not provide a fully readily usable thermoelectric engine nor does it provide for an efficient thermoelectric engine. In this disclosed invention, the small thickness of the thermoelectric engine insulation and the absence of significant physical distance between the hot side and cold side render the effectiveness of the thermoelectric assembly useless. Another significant aspect of today's market for thermoelectric portable consumer coolers is the need for drastic cost reduction, from manufacturing, to shipping, to material cost reduction. The prior arts described do not tend to focus on this aspect, although some offer small cost reduction when an integral thermoelectric engine is employed. However, in today's market, saving a little by using an integral thermoelectric engine is not enough. to be effectively competitive, cost savings must occur by using less material, cheaper material, facilitating the manufacturing and repair process, increasing the flexibility of the manufacturing process, reducing shipping cost, and yet without any loss of performance, quality, and safety. It is the purpose of this invention to disclose a radically new thermoelectric cooler that can address these market demands while correcting the short-comings of the prior arts.

Looking back again at the field of portable coolers, most are built using the typical three-layer architecture: an outside body made of hard material, an insulating layer made of flexible material, and an inside liner, made of hard material. Usually both body and liner provide the structural integrity to the product and the insulating layer provides the insulation mean. U.S. Pat. No. 6,244,458 to Frysinger, U.S. Pat. No. 4,873,841 to Bradshaw disclose such coolers. In the field of thermoelectric coolers, U.S. Pat. No. 5,319,937 to Fritsh and U.S. Pat. No. 6,073,789 to Lundblade also disclose coolers with such traditional construction. However, there is the available insulating technology today to reduce the cost of an insulated container. U.S. Pat. No. 6,014,833 to Benavidez, U.S. Design Pat. Des. 349,631 to Redmon and 270,804 to Caves disclose inventions utilizing inexpensive expanded polystyrene foam, also commonly know as Styrofoam™. It is the principal object of the present invention to disclose a thermoelectric portable cooler system addressing the technical and financial short-comings of the prior arts disclosed by providing an invention where the cooler's body permits significant cost reduction and ease of manufacture by using a low cost material easy to manufacture that can fulfill the role of both the insulating material and structural support material as well as offering a thermoelectric engine assembly that uses less components, eliminates the need for mounting hardware, is easily installable and removable, provides excellent insulation and efficiency, and can be used in a multitude of cooler applications. Because of the thermoelectric engine's simplistic construction and installation, it offers the manufacturer the flexibility to manufacture portion of the cooler at one location, and final assembly in another, saving on shipping cost, assembly cost, repair cost. The invention combining the innovative cooler body construction with innovative thermoelectric engine construction provides a much simplified, much inexpensive, much more reliable product that will bring innovative advantage to both the manufacturer and the consumer.

### BRIEF SUMMARY OF THE INVENTION

The primary object of the invention is to provide an inexpensive thermoelectric cooler.

Another object of the invention is to provide a thermoelectric cooler with minimum assembly process.

Another object of the invention is to provide a thermoelectric cooler with a one-piece thermoelectric heat pump assembly.

A further object of the invention is to provide a thermoelectric cooler with a one-piece thermoelectric heat pump having a one-step installation process.

Yet another object of the invention is to provide a thermoelectric cooler with a unibody construction.

Still yet another object of the invention is to provide a thermoelectric cooler with reduced shipping cost.

Another object of the invention is to provide a thermoelectric cooler with an easily replaceable thermoelectric heat pump assembly.

Another object of the invention is to provide a thermoelectric cooler using a cross-compatible thermoelectric heat pump assembly.

A further object of the invention is to provide a thermoelectric cooler with manufacturing location flexibility.

Yet another object of the invention is to provide a thermoelectric cooler easy to recycle.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a Thermoelectric Unibody Cooler Apparatus comprising: a unibody insulated vessel, a unibody insulated lid, and a removable thermoelectric heat pump assembly.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a perspective view of the invention's insulated vessel.

FIG. 3 is a perspective view of the invention's insulated lid.

FIG. 4 is a perspective view of the invention's thermoelectric heat pump assembly.

FIG. 5 is a cross sectional view of the invention's thermoelectric pump assembly.

FIG. 6 is a perspective partial view of the invention.

FIG. 7 is a perspective view of the invention.

### DETAILED DESCRIPTION OF THE PREFERRED EMBODIMENTS

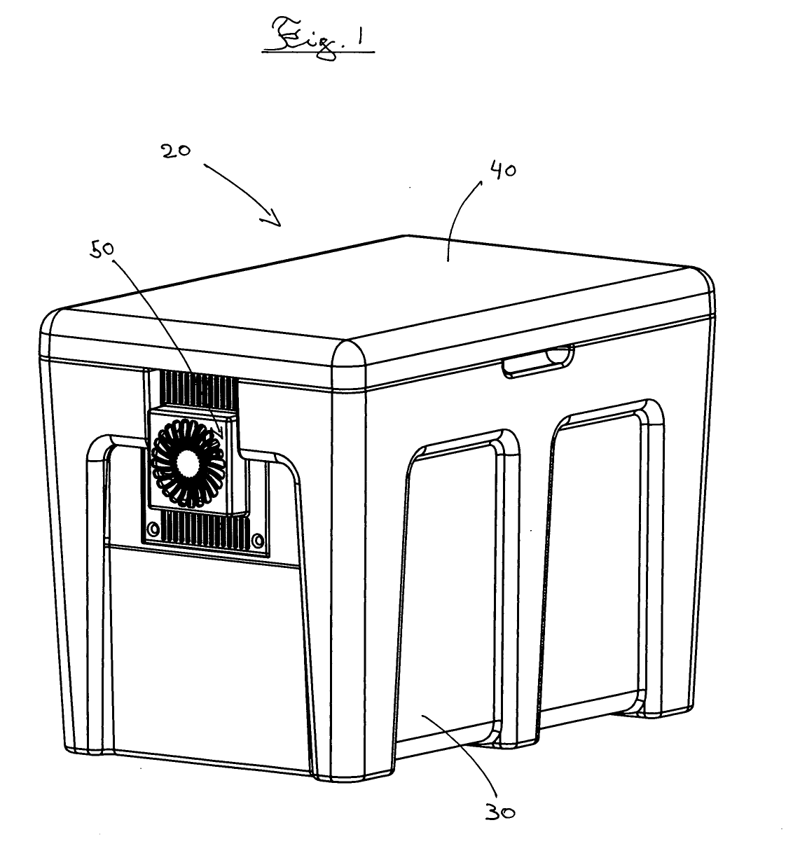

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Turning first to FIG. 1, there is shown a perspective view of the complete invention 20. The invention comprises a unibody insulated vessel 30, a unibody insulated lid 40, and a thermoelectric heat pump assembly 50. Together, this invention constitutes a portable thermoelectric cooler.

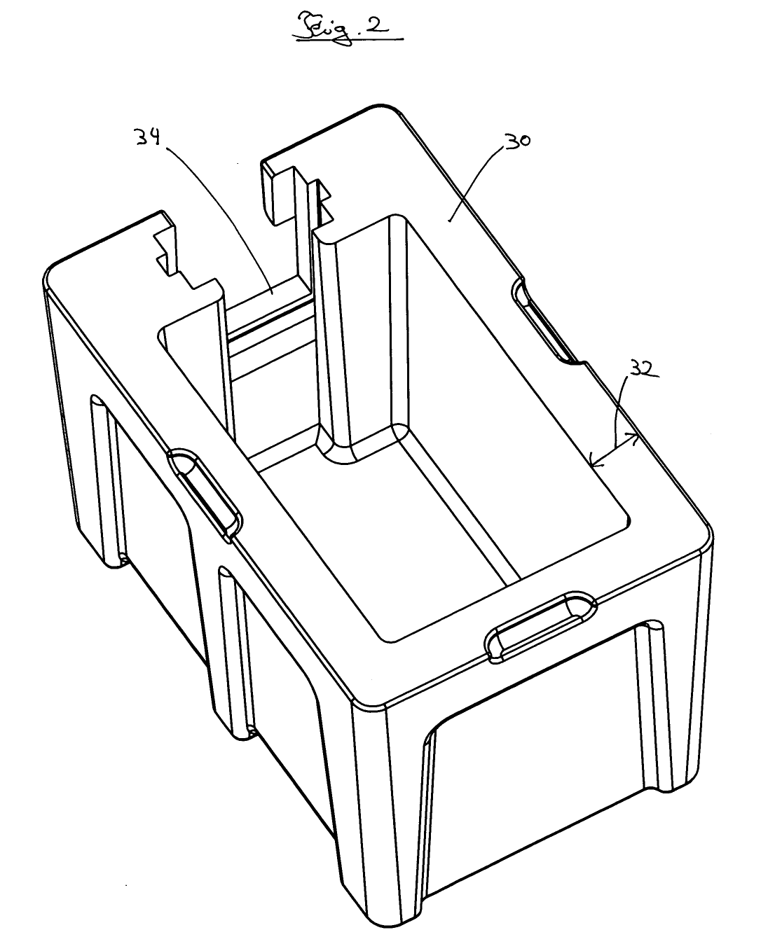

Now turning to FIG. 2, there is shown the unibody insulated vessel 30. In accordance with an important claim of the present invention, unibody insulated vessel 30 is manufactured as a single piece of semi-rigid insulating material. A variety of materials could be used such as expanded polystyrene foam, also known as EPS or Styrofoam™, or recycled EPS also known as ERG, or expanded polypropylene, or polyurethane foam. The list of materials useable for this application is not limited to the materials listed above. However, in accordance with another claim of the present invention, unibody insulated vessel is of adequate density and wall thickness 32 for this single piece of insulating material to be both the insulating mean and structural support mean. For example, in case EPS foam is the chosen material, a density ranging from about 1.5 to 5 pounds per cubic foot and a wall thickness no less than about 1.5 inches would be recommended. A lower density would not provide sufficient structural support and material integrity, while a higher density would excessively diminish the insulating properties of the material. A minimum wall thickness is required both to support the weight of the device and provide a useful environmental barrier with surrounding ambient conditions. Also shown in FIG. 2 is the compatible mounting area 34 where the thermoelectric heat pump assembly 50, not shown in this figure, bonds. This aspect of the present invention will be detailed further in this disclosure.

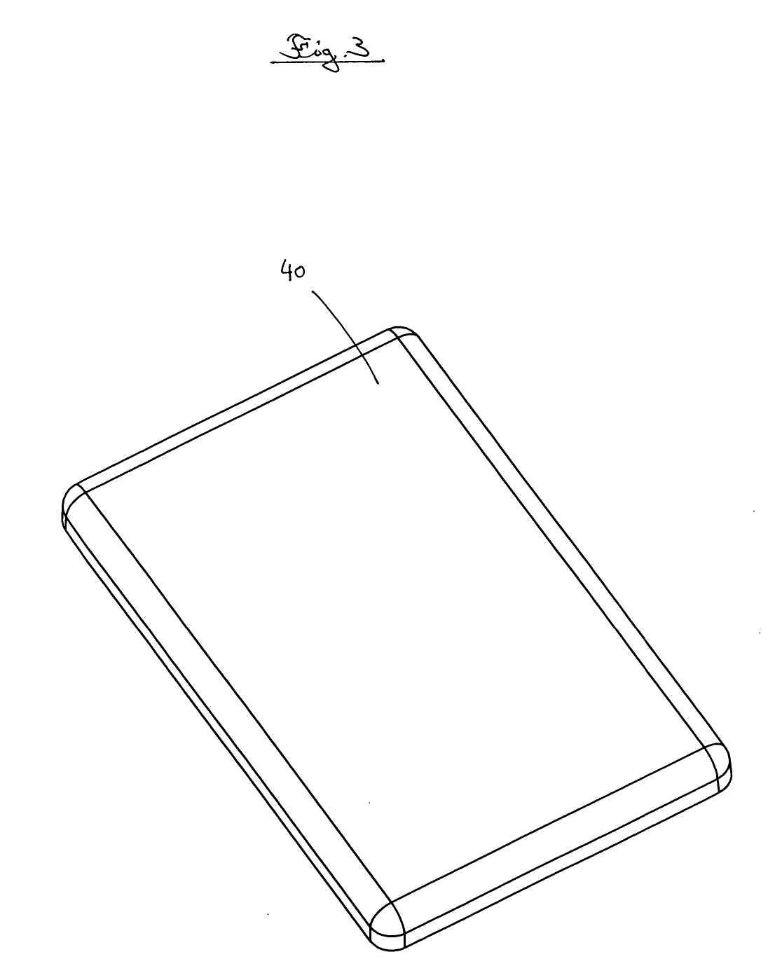

Turning now to FIG. 3, there is shown the unibody insulated lid 40. The same physical characteristics apply to the unibody insulated lid 40 as it does to the unibody insulated vessel 30. Unibody insulated lid is a one-piece component, manufactured using an insulating semi-rigid material of adequate density and thickness to structurally support and insulate the lid itself. The unibody insulated vessel and unibody insulated lid together constitute a very low cost, very easy to manufacture, lightweight cooler by using a single-layer construction using one material to perform both the insulating and mechanical support functions, a radically new concept in thermoelectric cooler applications.

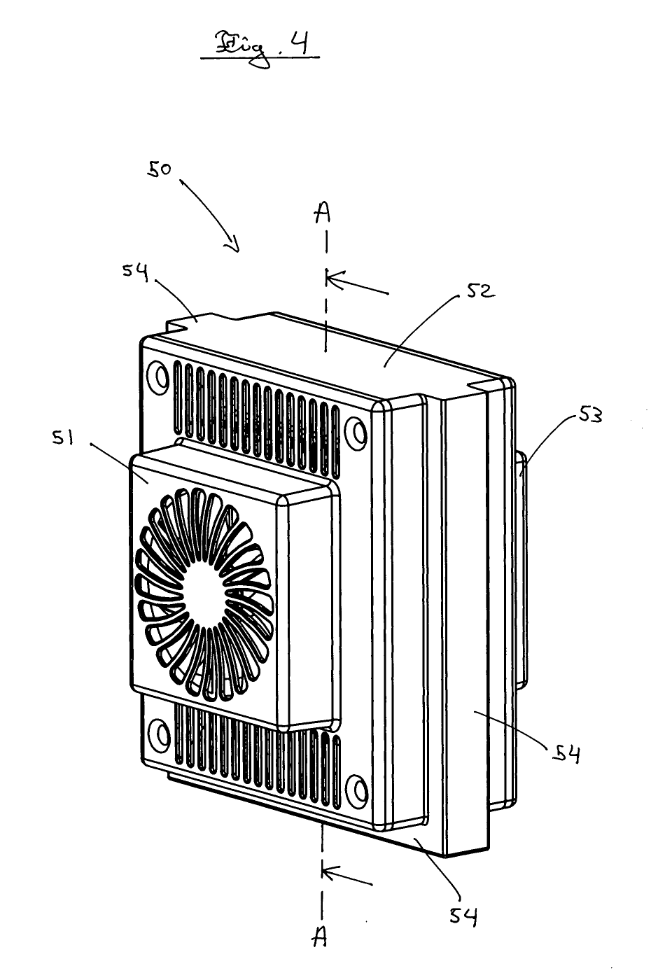

Now turning to FIG. 4, there is shown the thermoelectric heat pump assembly 50 assembled as one integral cassette, meaning it is a one piece by itself independently from the unibody insulated vessel and unibody insulated lid. Visible in this figure are the thermoelectric heat pump assembly hot side air channeling mean 51, commonly referred to as hot side fan cover; the thermoelectric heat pump assembly insulated interface 52; and the partially visible cold side air assembly mean 53, commonly referred to as cold side fan cover. The insulated interface 52 is manufactured as a single piece of semi-rigid insulating material, again such as EPS foam, comprising perimeter compressible surface features 54. A more detailed explanation of the functionality of insulated interface 52 and perimeter compressible surface features 54 will follow further in this disclosure.

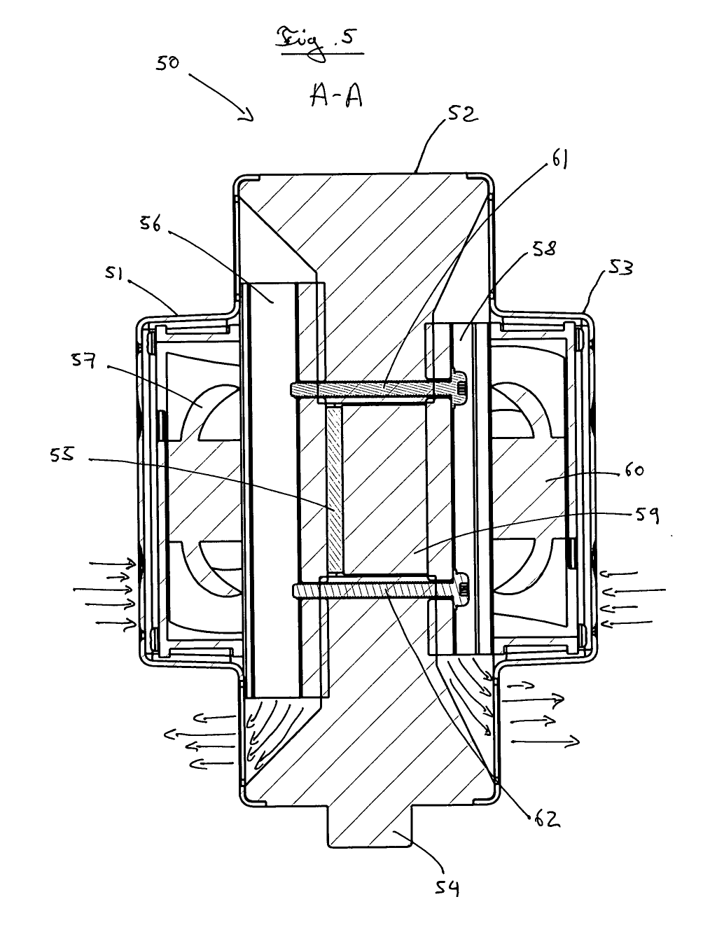

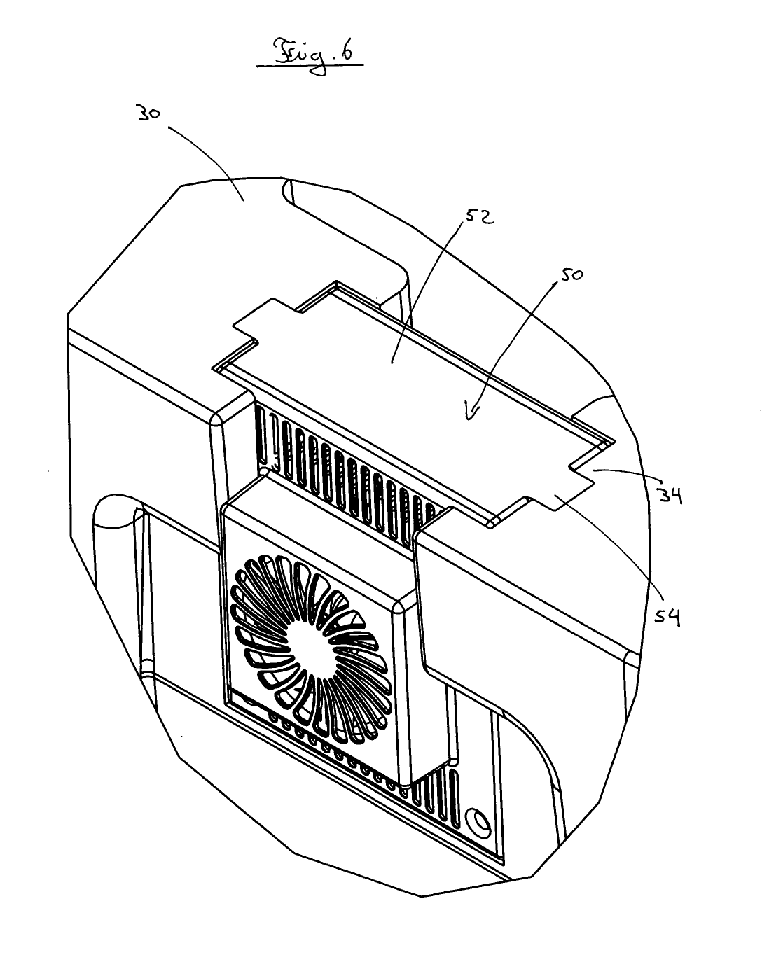

For a more in depth understanding of the thermoelectric heat pump assembly and in accordance with several claims of the present invention, we are now turning to FIG. 5. FIG. 5 shows cross-sectional view A-A of thermoelectric heat pump assembly 50. Cross-sectional view A-A is defined in FIG. 4. FIG. 5 reveals the outer and inner components of thermoelectric heat pump assembly 50. The assembly consists of the insulated interface 52 integrating thermoelectric element 55. Thermoelectric element 55 is a typical thermoelectric chip or Peltier effect chip commonly found in such consumer thermoelectric applications. All components on the left of thermoelectric element 55 are considered the thermoelectric assembly hot side and all components on the right of thermoelectric element 55 are considered the thermoelectric assembly cold side. Insulated interface 52 provides physical insulating distance between the assembly hot side and assembly cold side. The assembly hot side comprises metallic sink 56, also known as hot sink; air circulation mean 57, also known as hot side fan; and air channeling mean 51, also known as hot side fan cover. The assembly cold side comprises metallic sink 58, also known as cold sink; metallic spacer block 59, also known as cold block; air circulation mean 60, also known as cold side fan; and air channeling mean 53, also known as cold side fan cover. Also visible in FIG. 5 are perimeter compressible surface features 54. In accordance with an important aspect of the present invention, insulated interface 52 performs several functions: it is the thermoelectric heat pump assembly mounting interface as well as the insulating mean, a novelty construction in consumer thermoelectric assemblies offering great flexibility of design and significant cost saving. Additionally, insulated interface 52 does provide some air channeling mean assistance. In this preferred commercial embodiment, hot sink 56 is an adequate mass of aluminum shaped with a solid base and parallel fins. Hot side fan 57 sucks in outside fresh air through air intake openings in hot side fan cover 51, pushes the air over hot sink 56, expelling air through air exhaust openings in hot side fan cover 51. The same process is repeated on the cold side of the thermoelectric heat pump assembly where cold side fan 60 sucks in inside air through air intake openings in cold side fan cover 53, pushes air over finned cold sink 58 of adequate mass, expelling air through air exhaust openings in cold side fan cover 53. Metallic spacer block 59 provides for added physical distance between the assembly hot side and cold side for added performance. Metallic spacer block 59 and thermoelectric element 55 are fully integrated into insulated interface 52 providing an air-tight, moisture-tight barrier for better performance and longer product reliability. In this preferred commercial embodiment, thermoelectric heat pump assembly 50 is held together using screws 61 and 62. Now turning to FIG. 6 there is shown a partial perspective view of the invention. The partial view provides a close up of the thermoelectric heat pump assembly 50 assembled as one integral cassette with unibody insulated vessel 30. When assembled, the perimeter compressible features 54 of insulated interface 52 are compressed with compatible mounting area 34 of unibody insulated vessel 30 forming a dissengageable friction and thermal bond. In this preferred commercial embodiment, compatible mounting area 34 is of the same insulating compressible material as insulated interface 52, for example EPS. Using similar material insures that the two components will not damage each other during assembly, however is not a requirement or limitation in the present invention. In this preferred commercial embodiment, and to fulfill an important claim of the present invention, a preferred method to form a dissengageable friction and thermal bond between compatible mounting area 34 and insulated interface 52, compatible mounting area 34 is a mirror physical three dimensional image of insulated interface 52, with slightly smaller dimensions. When thermoelectric heat pump assembly 50 is installed with unibody insulated vessel 30, compatible mounting area 34 compresses perimeter compressible surface features 54 creating friction and thermal seal. The friction insures thermoelectric heat pump assembly 50 is secured in place during use, however remains removable if needed. Notably, this assembly method allows the installation or removal of the thermoelectric heat pump assembly 50 without the use of tools. Simultaneously, the tight friction fit between compatible mounting area 54 and insulated interface 52 provides an effective air-tight barrier adequately sealing the apparatus, an essential aspect for good performance of a thermoelectric system.

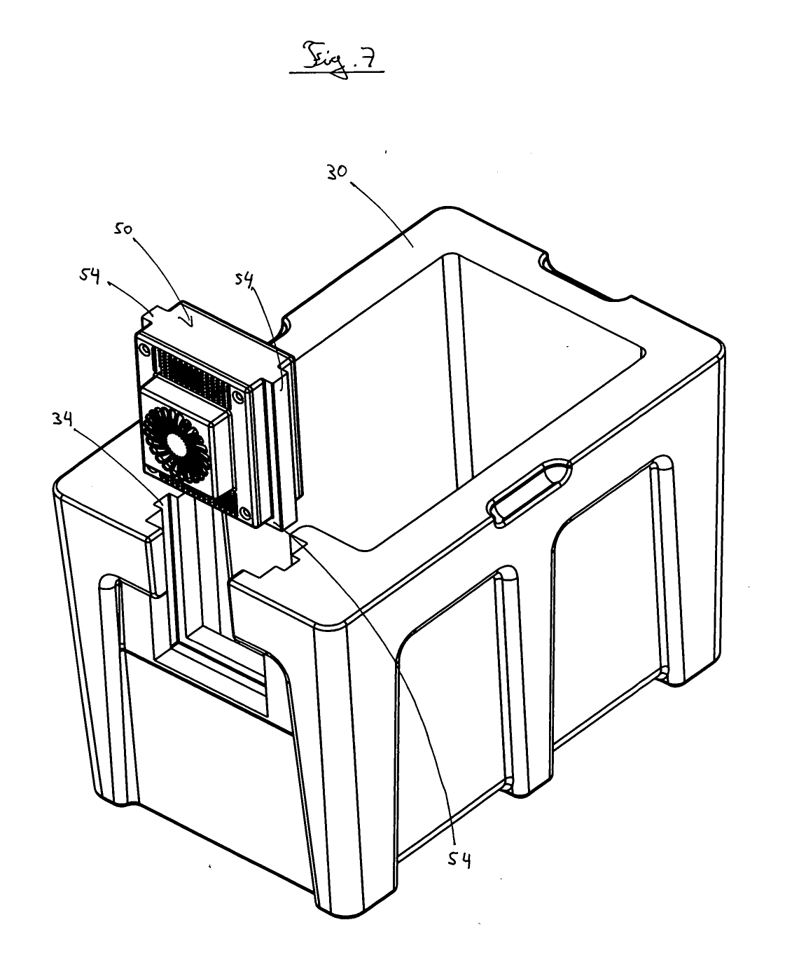

Lastly, FIG. 7 shows an exploded view, without unibody insulated lid 40 represented, of unibody insulated vessel 30 and thermoelectric heat pump assembly 50. This view shows how, in this preferred commercial embodiment, thermoelectric heat pump assembly 50 is assembled vertically from the top with compatible mounting area 34, and how compatible mounting area 34 is a mirror image of perimeter compressible surface features 54. Another commercial embodiment might use another configuration where the thermoelectric heat pump assembly could be assembled from the side with the insulated vessel using a different configuration and interface between perimeter compressible surface features and compatible mounting areas.

In conclusion, the above specifications disclose the present invention, in a preferred embodiment providing the following novelties and improvements over the prior art in this field. The present invention provides an inexpensive thermoelectric cooler by using very inexpensive construction materials, such as EPS, and reducing the amount of components, the body and lid of the invention are respectively manufactured as one piece. The present invention provides a thermoelectric cooler with minimum assembly process, the body and lid are one-piece components, the thermoelectric heat pump assembly is a one-piece cassette that can be assembled or removed without tools. Because the thermoelectric heat pump assembly is a one-piece cassette, it could be manufacture at one location, while the body and lid at another location; therefore, the invention provides manufacturing location flexibility and reduced shipping cost. The tool less installation or removal of the thermoelectric heat pump assembly provides easy repair option, easy recyclability. As for the thermoelectric heat pump assembly itself, combining the insulating mean with the mounting interface mean helps greatly simplify the assembly, providing for a lower cost and allowing the same thermoelectric heat pump assembly to be compatible with a wide variety of insulated vessels. Being able to re-use the same assembly with different products is a great cost saving for manufacturers who can therefore purchase individual components in greater quantities at a discounted cost.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Thermoelectric unibody cooler apparatus comprising:
a unibody insulated vessel;
a unibody insulated lid; and
a thermoelectric heat pump assembly.

2. Thermoelectric unibody cooler apparatus as claimed in claim 1 wherein said unibody insulated vessel is manufactured as a single piece of semi-rigid insulating material

3. Thermoelectric unibody cooler apparatus as claimed in claim 2 wherein said single piece of semi-rigid insulating material having adequate density and thickness is an insulating mean and a structural support mean

4. Thermoelectric unibody cooler apparatus as claimed in claim 1 wherein said unibody insulated lid is manufactured as a single piece of semi-rigid insulating material

5. Thermoelectric unibody cooler apparatus as claimed in claim 4 wherein said single piece of semi-rigid insulating material having adequate density and thickness is said lid insulating mean and said lid structural support mean

6. Thermoelectric unibody cooler apparatus comprising:
a unibody insulated vessel;
a unibody insulated lid; and
a thermoelectric heat pump assembly.

7. Thermoelectric unibody cooler apparatus as claimed in claim 6 wherein said thermoelectric heat pump assembly is assembled as one integral cassette and where said integral cassette forms a dissengageable friction and thermal bond with a compatible mounting area of said unibody insulated vessel

8. Thermoelectric unibody cooler apparatus as claimed in claim 7 wherein said integral cassette comprises a thermoelectric element, an assembly hot side, an assembly cold side, and an insulated interface integrating said thermoelectric element and part of said assembly cold side and where insulated interface provides physical insulating distance between said assembly hot side and said assembly cold side

9. Thermoelectric unibody cooler apparatus as claimed in claim 8 wherein said assembly hot side comprises a metallic sink, an air circulation mean, and an air channeling mean

10. Thermoelectric unibody cooler apparatus as claimed in claim 8 wherein said assembly cold side comprises a metallic sink, a metallic spacer block, an air circulation mean, and an air channeling mean

11. Thermoelectric unibody cooler apparatus as claimed in claim 8 wherein said insulated interface is manufactured as a single piece of semi-rigid insulating material comprising perimeter compressible surface features
